(19) United States
(12) Patent Application Publication
(10) Pub. No.: US 2021/0293922 A1
(43) Pub. Date: Sep. 23, 2021

(54) IN-VEHICLE APPARATUS, VEHICLE, AND CONTROL METHOD

(71) Applicant: HONDA MOTOR CO., LTD., Tokyo (JP)

(72) Inventor: Kenya Ikenaga, Wako-shi (JP)

(73) Assignee: HONDA MOTOR CO., LTD., Tokyo (JP)

(21) Appl. No.: 17/189,583

(22) Filed: Mar. 2, 2021

(30) Foreign Application Priority Data
Mar. 18, 2020 (JP) 2020-047988

(51) Int. Cl. G01S 7/40; G08G 1/16; G01S 13/931

(52) U.S. Cl. CPC G01S 7/40; B60W 30/0956; G01S 13/931; G08G 1/161

(57) ABSTRACT

The present invention provides an in-vehicle apparatus comprising: a detector that detects a position of a target around a self-vehicle using a radio wave; and one or more processors that: estimate a position of the target without using the detector; and decide a correction value for correcting a detection result of the detector based on a deviation between the detected position of the target by the detector and the estimated position of the target.

### CROSS-REFERENCE TO RELATED APPLICATION(S)

This application claims priority to and the benefit of Japanese Patent Application No. 2020-047988 filed on Mar. 18, 2020, the entire disclosure of which is incorporated herein by reference.

### BACKGROUND OF THE INVENTION

### Field of the Invention

The present invention relates to an in-vehicle apparatus, a vehicle, and a control method therefor.

### Description of the Related Art

Japanese Patent Laid-Open No. 2019-200121 discloses a radar system including a radar apparatus arranged to face the inner wall of a bumper, and a plurality of projecting portions formed on the inner wall of the bumper. In this radar system, to improve the radio wave permeability in a wide angle range, the plurality of projecting portions are formed to change the height in accordance with the incidence angle of a radio wave.

Since the radar apparatus described in Japanese Patent Laid-Open No. 2019-200121 is arranged inside the bumper, the radio wave passes through the bumper. In this case, an error may occur in the detection result of the radar apparatus due to the coating, thickness, and curvature of the bumper (a radio wave transmission portion), and it may thus be difficult to accurately detect the position of a target (for example, another vehicle) outside a vehicle using the radar apparatus.

### SUMMARY OF THE INVENTION

The present invention provides, for example, a technique advantageous in accurately detecting the position of a target outside a vehicle using a radio wave.

According to one aspect of the present invention, there is provided an in-vehicle apparatus comprising: a detector that detects a position of a target around a self-vehicle using a radio wave; and one or more processors that: estimate a position of the target without using the detector; and decide a correction value for correcting a detection result of the detector based on a deviation between the detected position of the target by the detector and the estimated position of the target.

Further features of the present invention will become apparent from the following description of exemplary embodiments with reference to the attached drawings.

### BRIEF DESCRIPTION OF THE DRAWINGS

FIG. 1 is a block diagram of a vehicle and a control apparatus;

FIG. 2 is a flowchart illustrating correction value decision processing;

FIG. 3 is a view showing an example of a situation in which the correction value decision processing is performed;

FIG. 4 is a graph showing an example of the relationship between the detection angle of a radar and an azimuth error;

FIG. 5 is a flowchart illustrating estimation processing of the position of another vehicle according to the second embodiment;

FIG. 6 is a view showing an example of setting of the traveling locus of the other vehicle according to the second embodiment; and

FIG. 7 is a view showing an example of setting of the traveling locus of the other vehicle according to the second embodiment.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### First Embodiment

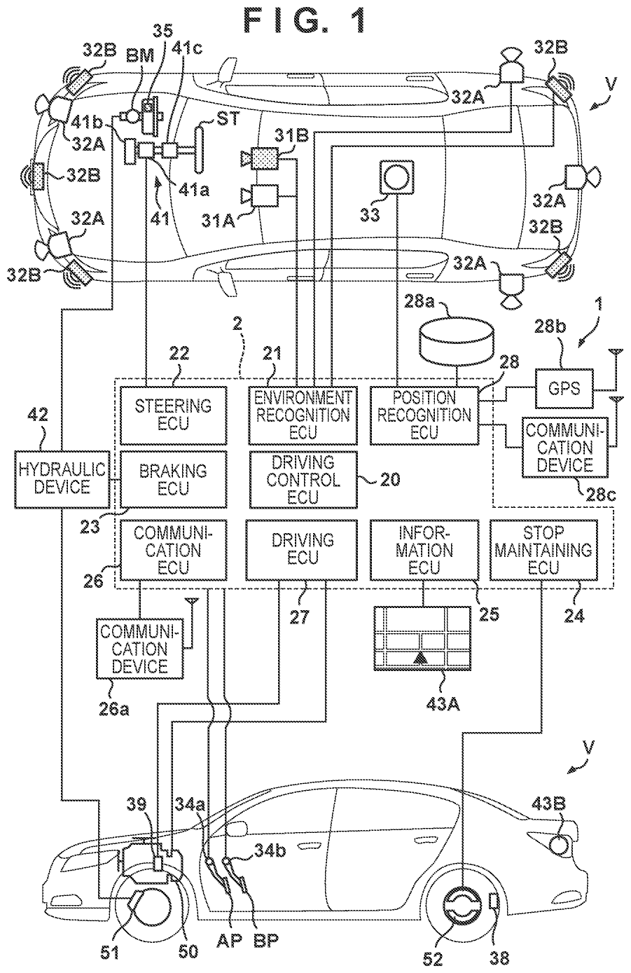

The first embodiment of the present invention will be described. FIG. 1 is a block diagram of a vehicle V and a control apparatus 1 for the vehicle V according to this embodiment. Referring to FIG. 1, a plan view and a side view show an outline of the vehicle V. As an example, the vehicle V is a sedan-type four-wheeled vehicle. The vehicle V according to this embodiment is, for example, a parallel-type hybrid vehicle. In this case, a power plant 50 that is a traveling driving unit configured to output a driving force to rotate the driving wheels of the vehicle V can include an internal combustion engine, a motor, and an automatic transmission. The motor can be used as a driving source configured to accelerate the vehicle V and can also be used as a power generator at the time of deceleration or the like (regenerative braking).

The arrangement of the control apparatus 1 that is an in-vehicle apparatus of the vehicle V will be described with reference to FIG. 1. The control apparatus 1 can include an information processing unit 2 formed by a plurality of ECUs 20 to 28 configured to be communicable with each other. Each ECU includes a processor represented by a CPU, a storage device such as a semiconductor memory, and an interface with an external device. The storage device stores programs to be executed by the processor, data to be used by the processor for processing, and the like. Each ECU may include a plurality of processors, storage devices, and interfaces. Note that the number of ECUs and the provided functions can appropriately be designed, and they can be subdivided or integrated as compared to this embodiment. Note that in FIG. 1, the names of the representative functions of the ECUs 20 to 28 are given. For example, the ECU 20 is denoted by “driving control ECU”.

The ECU 20 executes control concerning traveling support including driving control of the vehicle V. In this embodiment, the ECU 20 controls driving (acceleration of the vehicle V by the power plant 50, or the like), steering, and braking of the vehicle V. If the ECU 20 is configured to control automated driving of the vehicle V, the ECU 20 automatically performs driving, steering, and braking of the vehicle V without needing an operation of a driver. In addition, in manual driving, the ECU 20 can execute, for example, traveling support control such as collision mitigation braking and lane departure suppression. In the collision mitigation braking, if the possibility of collision against an obstacle on the front side is high, a brake device 51 is instructed to operate, thereby supporting collision avoidance. In the lane departure suppression, if the possibility of traveling lane departure of the vehicle V is high, an electric power steering device 41 is instructed to operate, thereby supporting lane departure avoidance.

The ECU 21 is an environment recognition unit configured to recognize the traveling environment of the vehicle V based on the detection results of detection units 31A, 31B, 32A, and 32B that detect the peripheral situation of the vehicle V. In this embodiment, the ECU 21 can detect the position of a target (for example, another vehicle) around the vehicle V based on at least one of the detection results of the detection units 31A, 31B, 32A, and 32B.

The detection units 31A, 31B, 32A, and 32B are sensors that can detect a target around the vehicle V (self-vehicle). The detection units 31A and 31B are cameras (to be sometimes referred to as the cameras 31A and 31B hereinafter) configured to capture the front side of the vehicle V, and are attached to the windshield inside the vehicle cabin at the roof front of the vehicle V. When images captured by the cameras 31A and 31B are analyzed, the contour of a target or a division line (a white line or the like) of a lane on a road can be extracted.

The detection unit 32A is a LIDAR (Light Detection and Ranging) (to be sometimes referred to as the LIDAR 32A hereinafter), and detects a target around the vehicle V and detects (measures) the distance to the target and the direction (azimuth) of the target. In the example shown in FIG. 1, five LIDARs 32A are provided; one at each corner of the front portion of the vehicle V, one at the center of the rear portion, and one on each side of the rear portion. The detection unit 32B is a millimeter wave radar (to be sometimes referred to as the radar 32B hereinafter), and detects a target around the vehicle V using a radio wave, and detects (measures) the distance to the target and the direction (azimuth) of the target. In the example shown in FIG. 1, five radars 32B are provided; one at the center of the front portion of the vehicle V, one at each corner of the front portion, and one at each corner of the rear portion.

The ECU 22 is a steering control unit configured to control the electric power steering device 41. The electric power steering device 41 includes a mechanism that steers the front wheels in accordance with the driving operation (steering operation) of the driver on a steering wheel ST. The electric power steering device 41 includes a driving unit 41a including a motor that generates a driving force (to be sometimes referred to as a steering assist torque hereinafter) to assist the steering operation or automatically steer the front wheels, a steering angle sensor 41b, and a torque sensor 41c that detects the steering torque (called a steering burden torque discriminated from the steering assist torque) on the driver.

The ECU 23 is a braking control unit configured to control a hydraulic device 42. A braking operation of the driver on a brake pedal BP is converted into a fluid pressure by a brake master cylinder BM and transmitted to the hydraulic device 42. The hydraulic device 42 is an actuator capable of controlling, based on the fluid pressure transmitted from the brake master cylinder BM, the fluid pressure of hydraulic oil to be supplied to the brake device (for example, a disc brake device) 51 provided in each of the four wheels. The ECU 23 performs driving control of a solenoid valve and the like provided in the hydraulic device 42. The ECU 23 can light a brake lamp 43B at the time of braking. This can increase the attention of a following vehicle to the vehicle V.

The ECU 23 and the hydraulic device 42 can form an electric servo brake. The ECU 23 can control, for example, the distribution of a braking force by the four brake devices 51 and a braking force by regenerative braking of the motor provided in the power plant 50. The ECU 23 can also implement an ABS function, traction control, and the posture control function for the vehicle V based on the detection results of a wheel speed sensor 38 provided in each of the four wheels, a yaw rate sensor (not shown), and a pressure sensor 35 configured to detect the pressure in the brake master cylinder BM.

The ECU 24 is a stop maintaining control unit configured to control an electric parking brake device 52 provided in each rear wheel. The electric parking brake device 52 includes a mechanism that locks the rear wheel. The ECU 24 can control lock and unlock of the rear wheels by the electric parking brake devices 52.

The ECU 25 is an in-vehicle notification control unit configured to control an information output device 43A that makes a notification of information inside the vehicle. The information output device 43A includes, for example, a head-up display or a display device provided on an instrument panel, or a voice output device. The information output device 43A may further include a vibration device. The ECU 25 causes the information output device 43A to output, for example, various kinds of information such as a vehicle speed and an atmospheric temperature, information such as a route guidance, and information concerning the state of the vehicle V.

The ECU 26 includes a communication device 26a for performing wireless communication. The communication device 26a can exchange information by wireless communication with a target having a communication function. Examples of the target having the communication function are a vehicle (inter-vehicle communication), a fixed facility (road-to-vehicle communication) such as a traffic signal or a traffic monitoring apparatus, and a human (pedestrian or bicycle) carrying a portable terminal such as a smartphone. The ECU 26 can acquire various kinds of information such as weather information by accessing a server or the like on the Internet by the communication device 26a.

The ECU 27 is a driving control unit configured to control the power plant 50. In this embodiment, one ECU 27 is assigned to the power plant 50. However, one ECU may be assigned to each of the internal combustion engine, the motor, and the automatic transmission. The ECU 27 controls the output of the internal combustion engine or the motor or switches the gear range of the automatic transmission in correspondence with, for example, the driving operation of the driver detected by an operation detection sensor 34a provided on an accelerator pedal AP or an operation detection sensor 34b provided on the brake pedal BP, the vehicle speed, or the like. Note that as a sensor that detects the traveling state of the vehicle V, a rotation speed sensor 39 that detects the rotation speed of the output shaft of the automatic transmission is provided in the automatic transmission. The vehicle speed of the vehicle V can be calculated from the detection result of the rotation speed sensor 39.

The ECU 28 is a position recognition unit configured to recognize the current position or the course of the vehicle V. The ECU 28 performs control of a gyro sensor 33, a GPS sensor 28b, and a communication device 28c and information processing of a detection result or a communication result. The gyro sensor 33 detects the rotary motion (yaw rate) of the vehicle V. The course of the vehicle V can be determined based on the detection result of the gyro sensor 33, and the like. The GPS sensor 28b detects the current position of the vehicle V. The communication device 28c performs wireless communication with a server configured to provide map information and traffic information, and acquires these pieces of information. A database 28a can store accurate map information. The ECU 28 can more accurately specify the position of the vehicle V on a lane based on the map information and the like. The vehicle V may be provided with a speed sensor configured to detect the speed of the vehicle V, an acceleration sensor configured to detect the acceleration of the vehicle V, and a horizontal acceleration sensor (horizontal G sensor) configured to detect the horizontal acceleration of the vehicle V.

In the vehicle V having the above-described arrangement, the radar 32B configured to detect a target around the vehicle V using a radio wave can be arranged inside the bumper (that is, in a space between the bumper and a vehicle body). In this case, the radio wave emitted from the radar 32B passes through the bumper to exit outside the vehicle. Therefore, an error occurs in the detection result of the position of the target by the ECU 21 due to the coating, thickness, and curvature of the bumper (a radio wave transmission portion), and it may thus be difficult to accurately detect the position of the target. To cope with this, the vehicle V (control apparatus 1) according to this embodiment decides a correction value for correcting the detection result of the position of the target using the radar 32B. By correcting the detection result of the position of the target using the correction value, it is possible to accurately detect the position of the target.

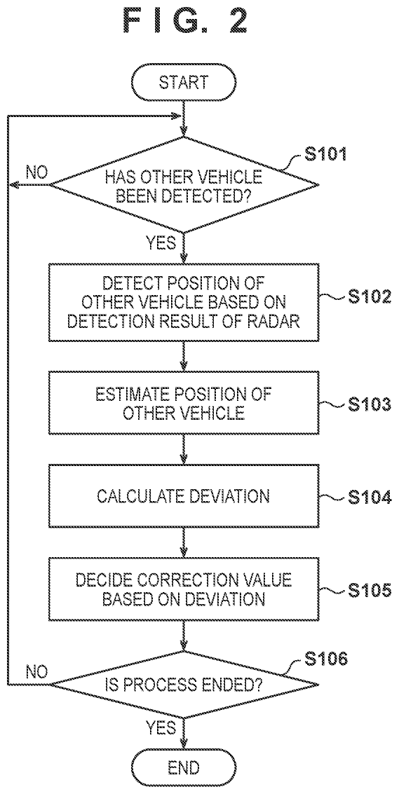

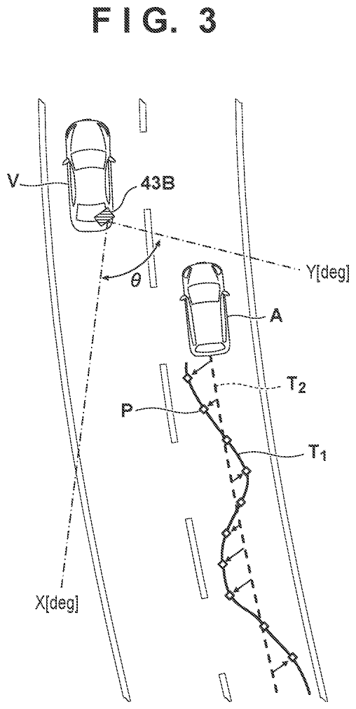

Correction value decision processing performed in the vehicle V according to this embodiment will be described next with reference to FIGS. 2 and 3. FIG. 2 is a flowchart illustrating the correction value decision processing. The flowchart shown in FIG. 2 can be performed by the information processing unit 2. FIG. 3 shows an example of a situation in which the correction value decision processing is performed. FIG. 3 shows the self-vehicle V and another vehicle A, and also shows a traveling locus T1 of the other vehicle A (target) detected by the ECU 21 using the radar 32B and a traveling locus T2 of the other vehicle A estimated using a unit different from the ECU 21 (i.e. without using the ECU 21 and the radar 32B). In this embodiment, the ECU 21 periodically detects the position of the other vehicle A based on the detection result of the radar 32B, and FIG. 3 shows, as plot points P, the position of the other vehicle periodically detected by the ECU 21.

In step S101, the information processing unit 2 (for example, the ECU 21) determines whether the radar 32B detects the other vehicle A as a target around the self-vehicle V. For example, based on the shape and behavior of the target detected by the radar 32B, the information processing unit 2 can determine whether the other vehicle A is detected as the target. If the radar 32B does not detect the other vehicle A, step S101 is repeatedly performed; otherwise, the process advances to step S102. Next, in step S102, the information processing unit 2 (for example, the ECU 21) detects the position (traveling locus T1) of the other vehicle A based on the detection result of the radar 32B. For example, the information processing unit 2 can detect the position (for example, the representative position, center position, or barycentric position) of the other vehicle A based on the direction (azimuth angle) in which the other vehicle A is detected by the radar 32B and the distance to the other vehicle A detected by the radar 32B.

In step S103, the information processing unit 2 estimates the position of the other vehicle A using a unit different from the radar 32B (ECU 21) (that is, without using the radar 32B). At this time, the information processing unit 2 estimates the position of the other vehicle A at a detection timing in step S102 using the unit different from the radar 32B (ECU 21). In this embodiment, the information processing unit 2 (for example, the ECU 20) estimates the position (traveling locus T2) of the other vehicle A using the communication device 26a (ECU 26). For example, the information processing unit 2 acquires traveling information of the other vehicle A by performing inter-vehicle communication with the other vehicle A by the communication device 26a (ECU 26). The other vehicle A has the same arrangement as that of the self-vehicle V described above, and the traveling information of the other vehicle A can include at least one piece of information among the position, speed, steering angle, rotary motion (yaw rate), and horizontal acceleration of the other vehicle A (the position information of the other vehicle A may be included essentially). This allows the information processing unit 2 to estimate the position of the other vehicle A based on the traveling information of the other vehicle A acquired by inter-vehicle communication. At this time, the information processing unit 2 may estimate the position of the other vehicle A as a relative position with respect to the self-vehicle V.

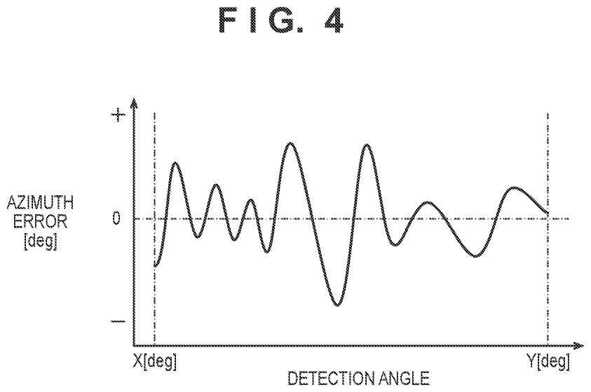

In step S104, the information processing unit 2 (for example, the ECU 20) calculates a deviation between the position of the other vehicle A detected in step S102 and the position of the other vehicle A estimated in step S103. The calculated deviation is stored in a storage device in association with the detection angle (azimuth angle) of the radar 32B. The deviation can be calculated as an azimuth error of the other vehicle A with respect to the self-vehicle V (radar 32B) and/or a distance error from the self-vehicle V (radar 32B) to the other vehicle A. As an example, FIG. 4 shows an example of the relationship between the detection angle of the radar 32B and the azimuth error. By repeatedly performing steps S101 to S104, it is possible to acquire the azimuth error in an angle range θ (X[deg] to Y[deg]) detectable by the radar 32B, and acquire the relationship between the detection angle and the azimuth error, as shown in FIG. 4. Note that similar to the azimuth error, with respect to the distance error as well, by repeatedly performing steps S101 to S104, it is possible to acquire the distance error in the angle range θ detectable by the radar 32B and acquire the relationship between the detection angle and the azimuth error.

In step S105, the information processing unit 2 (for example, the ECU 20) decides a correction value for correcting the detection result of the position of the target using the radar 32B based on the deviation calculated in step S104. For example, the information processing unit 2 can decide the reciprocal of the deviation as a correction value. As an example, if the correction value of the azimuth error is decided based on the relationship between the detection angle and the azimuth error shown in FIG. 4, the information processing unit 2 can decide the correction value of the azimuth error for each detection angle (that is, in correspondence with the detection angle) by deciding the reciprocal of the azimuth error as the correction value. Note that the correction value of the distance error can also be decided, similar to the correction value of the azimuth error.

In step S106, the information processing unit 2 (for example, the ECU 20) determines whether to end the correction value decision processing. For example, if the ignition is turned off or an end instruction is accepted from an occupant (for example, the driver), the information processing unit 2 can determine to end the correction value decision processing. Steps S101 to S106 are repeatedly performed until it is determined to end the correction value decision processing.

As described above, according to this embodiment, the correction value for correcting the detection result of the target using the radar 32B is decided based on the deviation between the position of the other vehicle A detected using the radar 32B and the position of the other vehicle A estimated based on the traveling information of the other vehicle A acquired by inter-vehicle communication. Then, the position of the target detected by the ECU 21 is corrected based on the detection result of the radar 32B using the thus decided correction value. This can accurately detect the position of the target using the radar 32B, and thus it is possible to execute accurate control (for example, automated driving control) of the vehicle V.

### Second Embodiment

The second embodiment of the present invention will be described. The first embodiment has explained the example of estimating the position of the other vehicle A based on the traveling information of the other vehicle A acquired by inter-vehicle communication in step S103 of the flowchart shown in FIG. 2. This embodiment will describe an example of estimating the position of another vehicle A based on a traveling locus T1 of a self-vehicle V in step S103. Note that this embodiment basically takes over the first embodiment. The arrangements (FIG. 1) of a vehicle and an apparatus, a processing procedure (FIG. 2), and the like are the same as in the first embodiment, unless otherwise specified.

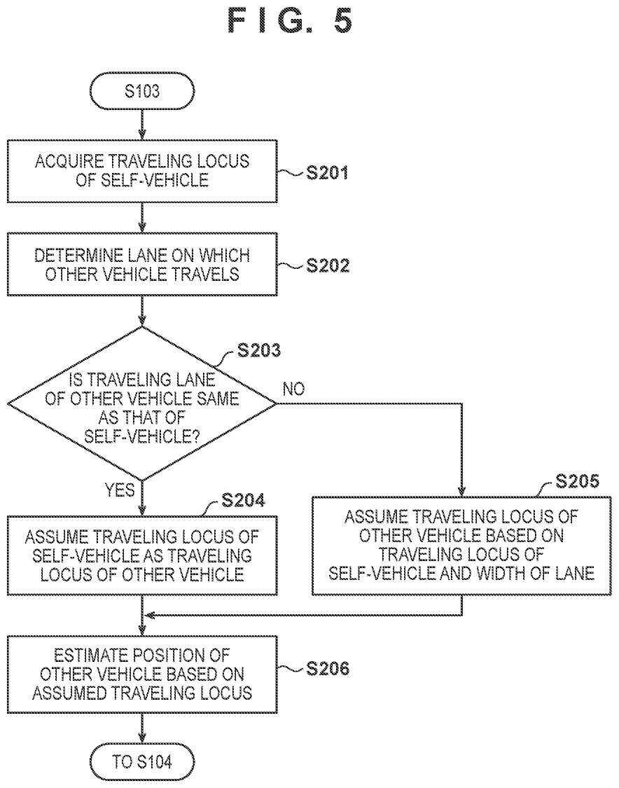

FIG. 5 is a flowchart illustrating processing (processing of estimating the position of the other vehicle A) performed in step S103 according to this embodiment. The flowchart shown in FIG. 5 can be performed by an information processing unit 2.

In step S201, the information processing unit 2 (for example, an ECU 28) acquires the traveling locus T1 of the self-vehicle V. For example, the information processing unit 2 can acquire (calculate) the traveling locus T1 of the self-vehicle V based on information representing the traveling state of the self-vehicle V. The information representing the traveling state of the self-vehicle V can include at least one piece of information among the rotary motion (yaw rate) of the self-vehicle V detected by a gyro sensor 33, the position of the self-vehicle V detected by a GPS sensor 28b, the speed of the self-vehicle V detected by a speed sensor, the acceleration of the self-vehicle V detected by an acceleration sensor, and the horizontal acceleration of the self-vehicle V detected by a horizontal acceleration sensor.

In step S202, the information processing unit 2 (for example, an ECU 20) determines a lane on which the other vehicle A currently travels. For example, the information processing unit 2 can determine the lane on which the other vehicle A currently travels, based on the detection angle of the other vehicle A by a radar 32B and map information acquired by a communication device 28c. In this embodiment, the self-vehicle V travels on a road including a plurality of lanes, as shown in FIG. 3, and the information processing unit 2 determines whether the other vehicle A travels on the same lane as that of the self-vehicle V or a lane adjacent to the traveling lane of the self-vehicle V.

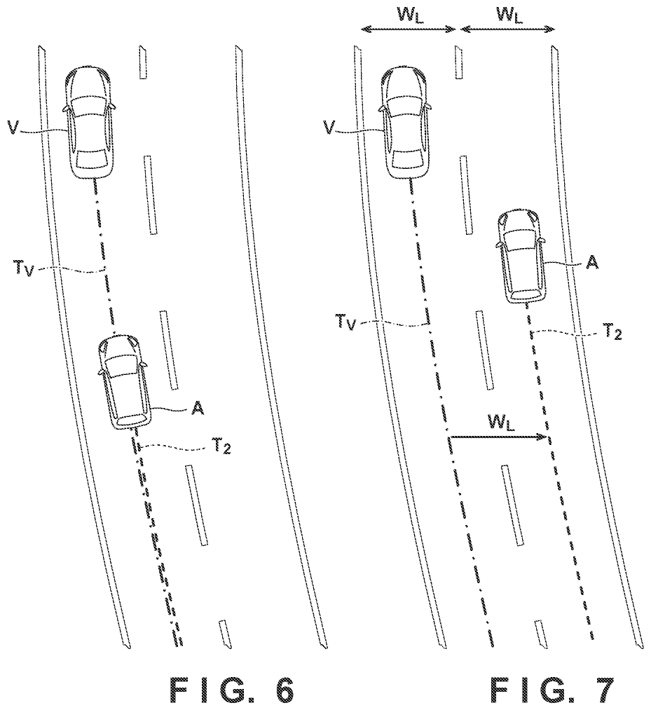

In step S203, the information processing unit 2 (for example, the ECU 20) determines, based on a determination result in step S202, whether the traveling lane of the other vehicle A is the same as that of the self-vehicle V. If it is determined that the traveling lane of the other vehicle A is the same as that of the self-vehicle V, the process advances to step S204. In step S204, the information processing unit 2 assumes that the other vehicle A travels along the traveling locus T1 of the self-vehicle V based on the traveling locus T1 of the self-vehicle V acquired in step S201, as shown in FIG. 6, thereby setting a traveling locus T2 of the other vehicle A. That is, in step S204, the information processing unit 2 assumes, as the traveling locus T2 of the other vehicle A, the traveling locus T1 of the self-vehicle V acquired in step S201.

On the other hand, if it is determined in step S203 that the traveling lane of the other vehicle A is different from that of the self-vehicle V, the process advances to step S205. In step S205, the information processing unit 2 sets the traveling locus T2 of the other vehicle A based on the traveling locus T1 of the self-vehicle V acquired in step S201 and information of a width WL of the lane. For example, assume that the other vehicle A travels on the lane adjacent to the traveling lane of the self-vehicle V, as shown in FIG. 7. In this case, the information processing unit 2 can set (assume), as the traveling locus T2 of the other vehicle A, a locus obtained by shifting, by the width WL of the lane, the traveling locus T1 of the self-vehicle V acquired in step S201. The information of the width WL of the lane can be obtained from, for example, the map information acquired via the communication device 28c.

In step S206, the information processing unit 2 estimates the position of the other vehicle A based on the traveling locus T2 of the other vehicle A set in step S204 or S205. At this time, the information processing unit 2 estimates the position of the other vehicle A at a detection timing in step S102.

As described above, this embodiment sets (assumes) the traveling locus T2 of the other vehicle A based on the traveling locus T1 of the self-vehicle V. This can estimate the position of the other vehicle A even if it is impossible to acquire the traveling information of the other vehicle A, for example, if the other vehicle A does not have the inter-vehicle communication function.

### Other Embodiments

In the above-described embodiments, the correction value for correcting the detection result of the position of the target using the radar 32B is decided using the other vehicle A traveling on the rear side of the self-vehicle V. The present invention, however, is not limited to this, and the correction value may be decided using another vehicle traveling on the front side of the self-vehicle V. If a plurality of radars 32B are provided in the self-vehicle V, the correction value may be decided for each radar 32B. Furthermore, when deciding the correction value, an arbitrary target may be used instead of the other vehicle A as long as its position is grasped in advance, without limitation to the other vehicle A.

### Summary of Embodiments

1. An in-vehicle apparatus (for example, 1) according to the above embodiment comprises

a detector (for example, 21, 32B) that detects a position of a target around a self-vehicle (for example, V) using a radio wave, and

one or more processors (for example, 20) that:

estimate a position of the target without using the detector, and

decide a correction value for correcting a detection result of the detector based on a deviation between the detected position of the target by the detector and the estimated position of the target.

According to this embodiment, since it is possible to readily and accurately decide the correction value for correcting the detection result of the detector by estimating the position of the target, it is possible to accurately detect the position of the target using the radio wave.

2. In the above embodiment,

the processors estimate the position of the target at a detection timing of the detector without using the detector.

According to this embodiment, it is possible to more accurately decide the correction value.

3. In the above embodiment,

the detector detects a position of another vehicle (for example, A) as the target,

the in-vehicle apparatus further comprises a communication device (for example, 26, 26a) acquiring traveling information of the other vehicle by inter-vehicle communication, and

the processor estimate a position of the other vehicle based on the traveling information acquired by the communication device.

According to this embodiment, since it is possible to accurately estimate the position of the other vehicle, calibration of the detector (radar) can be performed more correctly.

4. In the above embodiment,

the traveling information includes at least one of a position, a speed, a steering angle, a rotary motion, and a horizontal acceleration of the other vehicle.

According to this embodiment, it is possible to more accurately estimate the position of the other vehicle.

5. In the above embodiment,

the detector detects a position of another vehicle (for example, A) as the target,

the processors acquire a traveling locus (for example, T1) of the self-vehicle, assume a traveling locus (for example, T2) of the other vehicle based on the acquired traveling locus of the self-vehicle, and estimate a position of the other vehicle based on the assumed traveling locus of the other vehicle.

According to this embodiment, since it is possible to accurately estimate the position of the other vehicle, calibration of the detector (radar) can be performed more correctly.

6. In the above embodiment,

the processor estimate, in a case where it is determined that the other vehicle travels on the same lane as a lane of the self-vehicle, the position of the other vehicle by assuming the traveling locus of the self-vehicle as the traveling locus of the other vehicle.

According to this embodiment, it is possible to accurately estimate the position of the other vehicle.

7. In the above embodiment,

the processor estimate, in a case where it is determined that the other vehicle travels on a lane adjacent to a traveling lane of the self-vehicle, the position of the other vehicle by assuming, as the traveling locus of the other vehicle, a locus calculated based on the traveling locus of the self-vehicle and a width of the lane.

According to this embodiment, it is possible to accurately estimate the position of the other vehicle.

8. In the above embodiment,

the detector includes a radar (for example, 43B) arranged between a bumper and a vehicle body in the self-vehicle.

According to this embodiment, since the radar is arranged inside the bumper, it is possible to widen the degree of freedom of vehicle design.

The invention is not limited to the foregoing embodiments, and various variations/changes are possible within the spirit of the invention.

What is claimed is:

1. An in-vehicle apparatus comprising:
a detector that detects a position of a target around a self-vehicle using a radio wave; and
one or more processors that:
estimate a position of the target without using the detector; and
decide a correction value for correcting a detection result of the detector based on a deviation between the detected position of the target by the detector and the estimated position of the target.

2. The apparatus according to claim 1, wherein the processors estimate the position of the target at a detection timing of the detector without using the detector.

3. The apparatus according to claim 1, wherein
the detector detects a position of another vehicle as the target,
the in-vehicle apparatus further comprises a communication device acquiring traveling information of the other vehicle by inter-vehicle communication, and
the processors estimate a position of the other vehicle based on the traveling information acquired by the communication device.

4. The apparatus according to claim 3, wherein the traveling information includes at least one of a position, a speed, a steering angle, a rotary motion, and a horizontal acceleration of the other vehicle.

5. The apparatus according to claim 1, wherein
the detector detects a position of another vehicle as the target,
the processors acquire a traveling locus of the self-vehicle, assume a traveling locus of the other vehicle based on the acquired traveling locus of the self-vehicle, and estimate a position of the other vehicle based on the assumed traveling locus of the other vehicle.

6. The apparatus according to claim 5, wherein the processor estimate, in a case where it is determined that the other vehicle travels on the same lane as a lane of the self-vehicle, the position of the other vehicle by assuming the traveling locus of the self-vehicle as the traveling locus of the other vehicle.

7. The apparatus according to claim 5, wherein the processor estimate, in a case where it is determined that the other vehicle travels on a lane adjacent to a traveling lane of the self-vehicle, the position of the other vehicle by assuming, as the traveling locus of the other vehicle, a locus calculated based on the traveling locus of the self-vehicle and a width of the lane.

8. The apparatus according to claim 1, wherein the detector includes a radar arranged between a bumper and a vehicle body in the self-vehicle.

9. A vehicle including an in-vehicle apparatus defined in claim 1.

10. A control method for a vehicle including a detector that detects a position of a target around a self-vehicle using a radio wave, the method comprising:
estimating a position of the target without using the detector; and
deciding a correction value for correcting a detection result of the detector based on a deviation between the detected position of the target by the detector and the estimated position of the target in the estimating.
